(19) United States
(12) Patent Application Publication
(10) Pub. No.: US 2005/0200424 A1
(43) Pub. Date: Sep. 15, 2005

(54) Microstripline waveguide converter

(75) Inventors: Hideji Takeda, Tokyo (JP); Hideki Asao, Tokyo (JP); Hideki Tsuzuki, Tokyo (JP); Akiko Katayama, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Tokyo (JP)

(21) Appl. No.: 10/909,411

(22) Filed: Aug. 3, 2004

(30) Foreign Application Priority Data
Mar. 11, 2004 (JP) 2004-69159

(51) Int. Cl. H01P 5/107

(52) U.S. Cl. 333/26

(57) ABSTRACT

In the inside of the converting portion of a microstripline waveguide converter, on the backside surface of a dielectric substrate, which constitutes, for example, a “stripline antenna,” a strip conductor pattern, which serves as a half-wavelength strip resonator, is disposed, to thereby add a band rejection function to the converter. The size of the converter is thereby reduced.

### BACKGROUND OF THE INVENTION

1. Field of the Invention

The present invention relates to a microstripline waveguide converter used mainly in a microwave band and a millimeter wave band.

2. Description of Related Art

As a conventional microstripline waveguide converter, for example, JP-A-2000-244212 discloses a converter in which a microstripline is extended to form a stripline antenna, the antenna is inserted in the opening of a waveguide, and one of the surfaces of the waveguide is short-circuited at the position that is approximately one quarter of the guide wavelength from the pattern of a strip conductor. According to this technique, because the magnetic field in the waveguide becomes the maximum at the position at which the strip conductor pattern is inserted, the propagation mode of the microstripline and that of the waveguide well couple with each other, and the high frequency signal that has been propagated through the microstripline can be propagated to the waveguide without causing a heavy loss. However, the converter using this technique does not have a function of reducing unwanted waves.

For this reason, as a technique for reducing unwanted waves, for example, JP-A-2003-008313 discloses a configuration in which a microstripline is extended in the opposite direction of the waveguide, and a notch is provided in the ceiling of the portion in the microstripline is inserted, to thereby cause the notch to constitute a filter, or to cause the microstripline to constitute a filter. Thus, conventionally, a configuration in which a filter is designed separately from a microstripline waveguide converter, and then these devices are combined has been often used.

As above described, when a function of attenuating unwanted waves is required in the conventional microstripline waveguide converter, the space for a filter is separately needed. Moreover, when the distance between the filter and the microstripline waveguide converter is short, there is a problem that the size reduction of the converter is difficult because of the occurrence of their mutual interference.

In addition, when the dielectric substrate constituting the filter is different from the substrate constituting the microstripline waveguide converter, a working process in which these substrates are connected by using gold wire or gold ribbon is required. Further, because these wire and ribbon easily lead to reflection, there is a problem that the electric characteristics of the converter can be deteriorated if the accuracy of the assembly is not high.

### SUMMARY OF THE INVENTION

The present invention has been accomplished to solve the above-mentioned problem, and an object of the present invention is to provide a microstripline waveguide converter that has a band rejection function.

The microstripline waveguide converter according to one aspect of the present invention includes: a waveguide having an opening hole in the sidewall thereof, and having a short-circuited surface on one of the ends thereof; a dielectric substrate extending through this opening hole of the waveguide toward the inside of the waveguide; a ground conductor pattern formed on one surface of this dielectric substrate, and mounted in the opening hole of the waveguide; a strip conductor pattern for transmitting a signal, formed on the other surface of the dielectric substrate and extending to the inside of the waveguide; and a strip conductor pattern for resonance, which is adjacent to this strip conductor pattern, is electrically insulated from the waveguide, is formed on the portion of the dielectric substrate, which is located within the waveguide, and has a finite length.

Further, the microstripline waveguide converter according to another aspect of the present invention includes: a waveguide having an opening hole in the sidewall thereof, and having a short-circuited surface on one of the ends thereof; a multilayered dielectric substrate extending through this opening hole of the waveguide toward the inside of the waveguide; a ground conductor pattern formed on both the outer layer surfaces of this dielectric substrate, and mounted in the opening hole of the waveguide; a strip conductor pattern for transmitting a signal, formed on the inner layer surface of the dielectric substrate, and extending to the inside of the waveguide; and a strip conductor pattern for resonance, which is adjacent to this strip conductor pattern, is electrically insulated from the waveguide, is formed on the portion of the dielectric substrate, which is located within the waveguide, and has a finite length.

Moreover, the microstripline waveguide converter according to still another aspect of the present invention includes: a waveguide one end of which is opened; a multilayered dielectric substrate that is mounted so as to close the opened portion of this waveguide; a ground conductor pattern that is formed on one outer layer surface of the dielectric substrate, corresponding to the wall of the section of the waveguide in the opened portion; a short-circuit conductor pattern that is formed on the other outer layer surface of the dielectric substrate; a strip conductor pattern for transmitting a signal, which is formed on one inner layer surface of the dielectric substrate, and extends to the inside of the waveguide; a strip conductor pattern for resonance, which is adjacent to this strip conductor pattern, is electrically insulated from the waveguide, is formed on the portion of the dielectric substrate, which is located within the waveguide, and has a finite length; and a conductor for connection, which is formed through the dielectric substrate, and electrically short-circuits the ground conductor pattern and the short-circuit conductor pattern.

Therefore, according to the present invention, a circuit having a band rejection function is provided within the converting portion of a microstripline waveguide converter, thereby enabling the size reduction of the converter.

Furthermore, according to the present invention, a band rejection function and a microstripline waveguide converter are completely integrated into a single device, thereby enabling the elimination of the working process of connecting the filter with the microstripline waveguide converter.

In addition, according to the present invention, the need for the interconnection between the filter and the microstripline waveguide converter and the need for the connection thereof using gold wire and gold ribbon, which both easily lead to the reflection of a high frequency signal, are eliminated, thereby enabling the enhancement of the electric characteristics of the converter.

### BRIEF DESCRIPTION OF THE DRAWINGS

FIG. 1 is a perspective view of the configuration of a microstripline waveguide converter according to a first embodiment of the present invention;

FIG. 2 is a sectional view of the configuration of the microstripline waveguide converter according to the first embodiment of the present invention;

FIG. 3 illustrates a conductor pattern disposed on the top surface of the dielectric substrate shown in FIG. 1;

FIG. 4 illustrates conductor patterns disposed on the bottom surface of the dielectric substrate shown in FIG. 1;

FIG. 5 illustrates the passing characteristic of the microstripline waveguide converter having a band rejection function, which is prototyped in the Ka band according to the first embodiment of the present invention;

FIG. 6 is a perspective view of the configuration of a microstripline waveguide converter according to a second embodiment of the present invention;

FIG. 7 illustrates conductor patterns disposed on the bottom surface of the dielectric substrate shown in FIG. 6;

FIG. 8 illustrates the alternatives of the shape of a conductor pattern disposed on the bottom surface of the dielectric substrate shown in FIG. 7;

FIG. 9 is a perspective view of the configuration of a microstripline waveguide converter according to a third embodiment of the present invention;

FIG. 10 illustrates conductor patterns disposed on the bottom surface of the dielectric substrate shown in FIG. 9;

FIG. 11 is a perspective view of the configuration of a microstripline waveguide converter according to a fourth embodiment of the present invention;

FIG. 12 illustrates conductor patterns disposed on the bottom surface of the dielectric substrate shown in FIG. 11;

FIG. 13 is a perspective view of the configuration of a microstripline waveguide converter according to a fifth embodiment of the present invention;

FIG. 14 is a perspective view of the configuration of a microstripline waveguide converter according to a sixth embodiment of the present invention;

FIG. 15 is a perspective view of the configuration of a microstripline waveguide converter according to a seventh embodiment of the present invention;

FIG. 16 is a sectional view of the configuration of the microstripline waveguide converter according to the seventh embodiment of the present invention;

FIG. 17 is a perspective view of the configuration of a microstripline waveguide converter according to an eighth embodiment of the present invention;

FIG. 18 is a sectional view of the configuration of the microstripline waveguide converter according to the eighth embodiment of the present invention;

FIG. 19 is a sectional view of the configuration of the microstripline waveguide converter according to the eighth embodiment of the present invention;

FIG. 20 is a perspective view of the configuration of a microstripline waveguide converter according to a ninth embodiment of the present invention; and

FIG. 21A and FIG. 21B are a perspective view and a sectional view, respectively, of the configuration of a microstripline waveguide converter according to a tenth embodiment of the present invention.

### DETAILED DESCRIPTION OF THE PREFERRED EMBODIMENTS

An embodiment of the present invention will be described below.

### First Embodiment

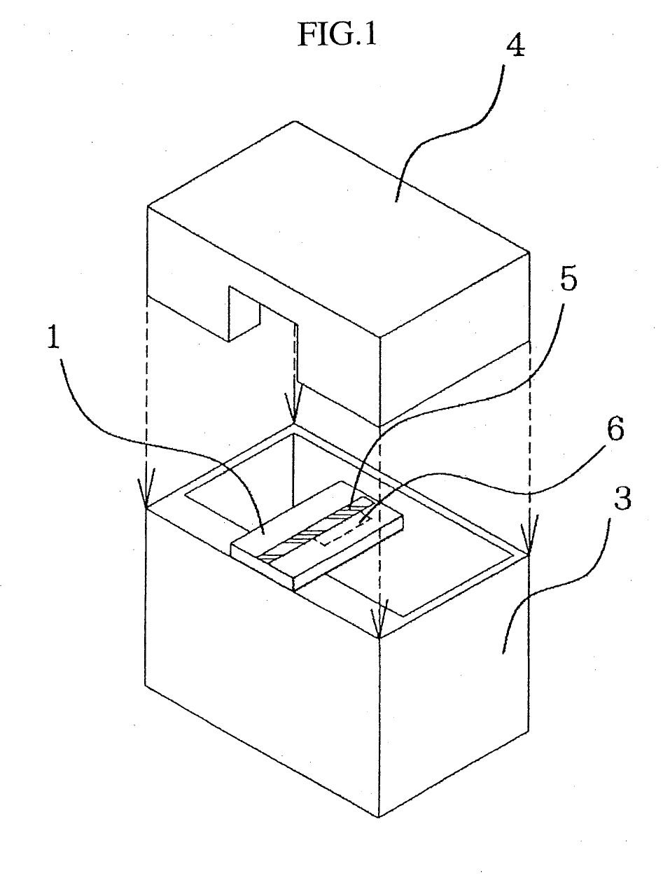

The configuration of a microstripline waveguide converter according to a first embodiment of the present invention will now be described by reference to FIGS. 1-5.

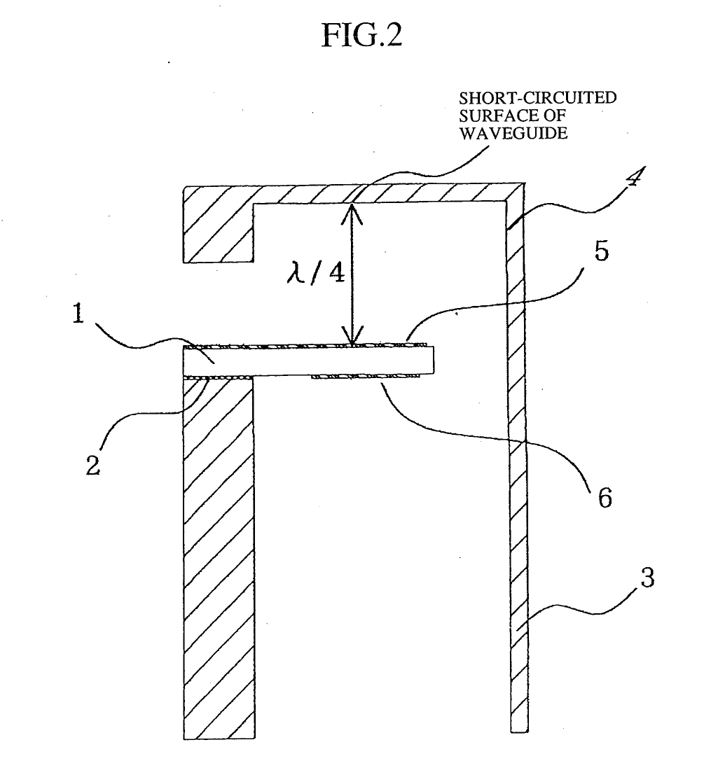

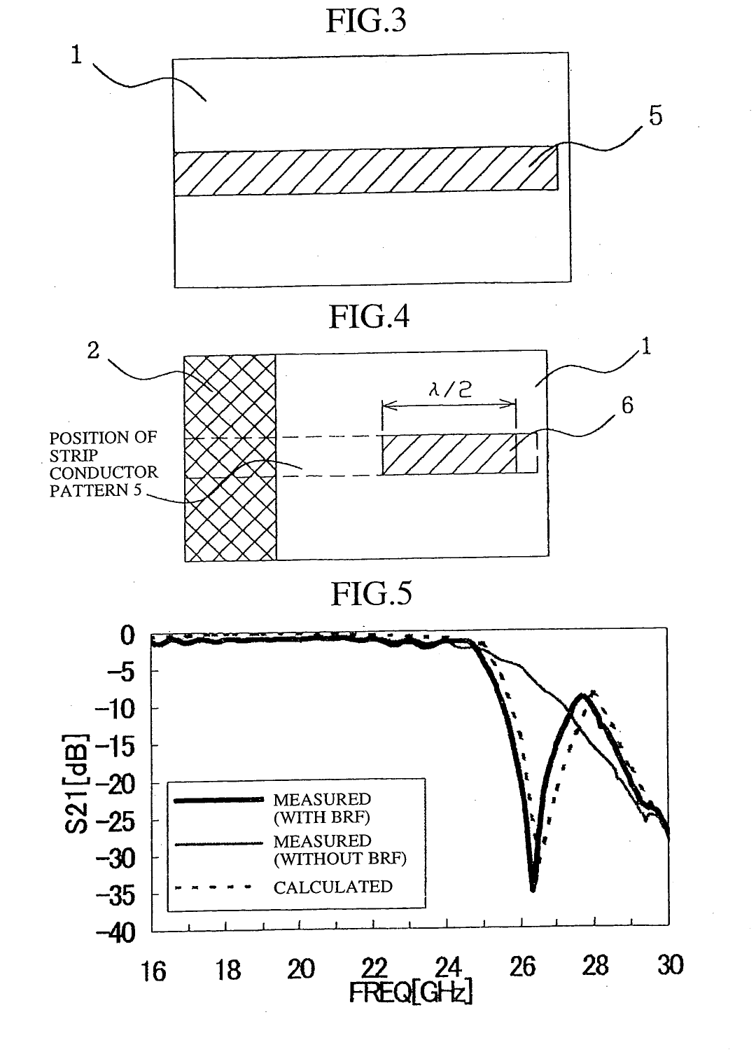

FIG. 1 is a perspective view of the configuration of the microstripline waveguide converter according to the first embodiment of the present invention. FIG. 2 is a sectional view of the microstripline waveguide converter shown in FIG. 1. FIG. 3 illustrates a conductor pattern disposed on the top surface of the dielectric substrate shown in FIG. 1 and FIG. 2. FIG. 4 illustrates conductor patterns disposed on the bottom surface of the dielectric substrate.

In FIGS. 1-4, the reference numeral 1 represents a dielectric substrate, the numeral 2 represents a ground conductor pattern, the numeral 3 represents a waveguide, the numeral 4 represents a short-circuited waveguide block, and the numerals 5 and 6 represent strip conductor patterns formed on the dielectric substrate 1, respectively. In these figures, the dielectric substrate 1 is secured so as to be disposed between the waveguide 3 and the short-circuited waveguide 4. One surface of the dielectric substrate is provided with the strip conductor pattern 5, and the other surface is provided with the strip conductor pattern 6 and the ground conductor pattern 2, which is connected with the opening portion of the waveguide 3, respectively.

The dielectric substrate 1 is secured to the waveguide 3, for example, by bonding the ground conductor pattern 2 to the wall of the opening of the waveguide via a bonding member (solder, electro-conductive adhesive, or the like).

The short-circuited waveguide block 4 is secured to the waveguide 3, for example, by screwing the block on the waveguide 3 in its four corners.

Moreover, in these figures, the dielectric substrate 1, the ground conductor pattern 2, and the strip conductor pattern 5 constitute a “microstripline.” Further, in the inside of the waveguide 3, the dielectric substrate 1 and the strip conductor pattern 5 constitute a “stripline antenna.” Additionally, in the inside of the waveguide 3, the dielectric substrate 1 and the strip conductor pattern 6 constitute a “half-wavelength strip resonator.”

The position of the dielectric substrate 1 is adjusted such that the position of the strip conductor pattern 6 is one-quarter of the guide wavelength of the waveguide from the wall surface of the short-circuited waveguide block 4.

The operation of the microstripline waveguide converter according to the first embodiment will now be described as below by reference to the figures.

In the microstripline, an electric field is generated between the ground conductor pattern 2 and the strip conductor pattern 5. Meanwhile, in the waveguide 3, an electric field is most highly distributed in the central portion in the section of the waveguide. In the passing band, when the strip conductor pattern 5 constituting the microstripline and the waveguide 3 are coupled such that the strong portions in these electric fields of the strip conductor pattern and of the waveguide match with each other, the propagation mode in the microstripline and the one in the waveguide 3 well couple with each other, and the high frequency signal, which has been propagated through the microstripline, can be propagated to the waveguide 3 without intensively reflecting.

Meanwhile, the strip conductor pattern 6 is arranged so as to have a length that is approximately one-half of the wavelength of the unwanted wave (this wavelength is the wavelength converted on the dielectric substrate 1 when causing the strip conductor pattern 5 to serve as the ground conductor, and the wavelength is determined by the boundary conditions such as the surrounding walls of the waveguide), and the strip conductor pattern 6 is disposed at the position on the back of the strip conductor pattern 5 via the dielectric substrate 1. In such a way, the strip conductor pattern 6 serves as a resonance circuit, which resonates in the mode of the microstripline mainly with the strip conductor pattern 5 as the ground conductor, thereby reducing the unwanted waves. Here, the length of the strip conductor pattern 5, which projects into the waveguide 3, is comparatively short; however, because the strip conductor pattern 6 resonates in the mode of the microstripline using the dielectric substrate, the length thereof can be shorten compared with the length of the free space, thereby enabling the formation of a small resonance circuit.

The passing characteristics of the microstripline waveguide converter having a band rejection function, which is prototyped in the Ka band according to the first embodiment, are shown in FIG. 5. The passing characteristics, about −1 dB or more in the passing band 16-20 GHz and about −15 dB or less in the rejection band 26-27 GHz are obtained. Moreover, in FIG. 5, the passing characteristics of the microstripline waveguide converter measured when the band rejection function was not used are shown in addition to the above data; and in that case, the characteristics thereof are about −1 dB or more in the passing band, and about −5 dB or less in the rejection band. Accordingly, it is understood that the microstripline waveguide converter having the band rejection function according to the first embodiment can reduce only the unwanted waves without deteriorating the characteristics in the passing band.

As mentioned above, according to the first embodiment, the band rejection function can be provided in the inside of the converting portion of the microstripline waveguide converter, thereby enabling the size reduction of the converter. In addition, the need for the working process of connecting the filter with the microstripline waveguide converter can be eliminated, and further the needs for the interconnection between the filter and the microstripline waveguide converter and for the connection using gold wire and gold ribbon, both easily leading to the reflection of high frequency signals can be also eliminated. Therefore, the electric characteristics of the converter can be enhanced.

### Second Embodiment

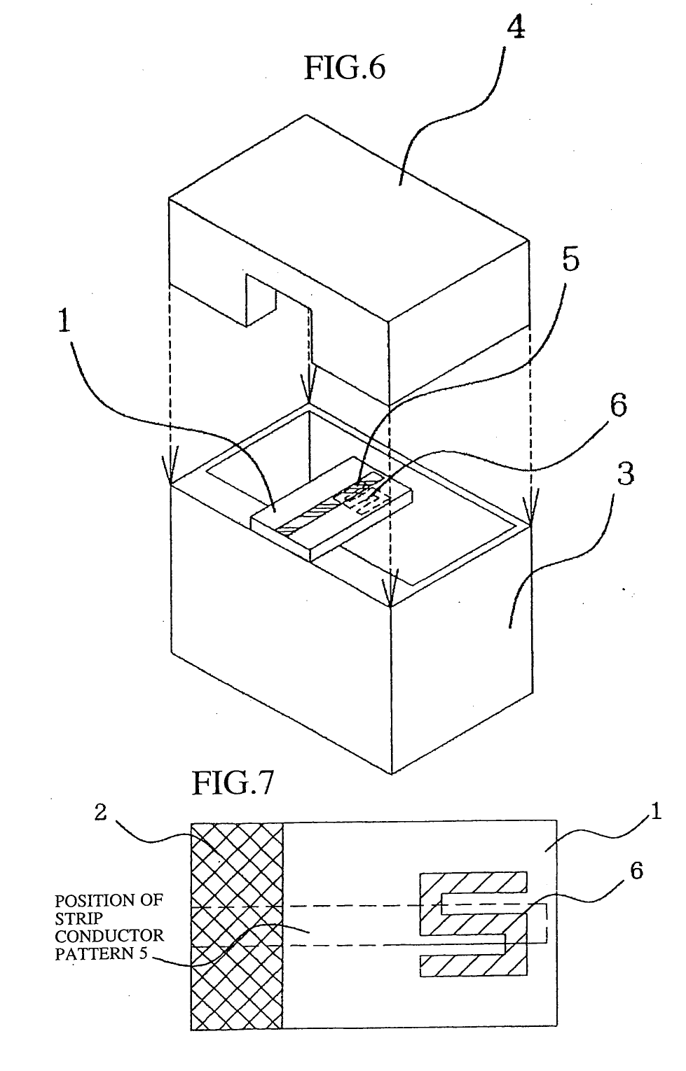

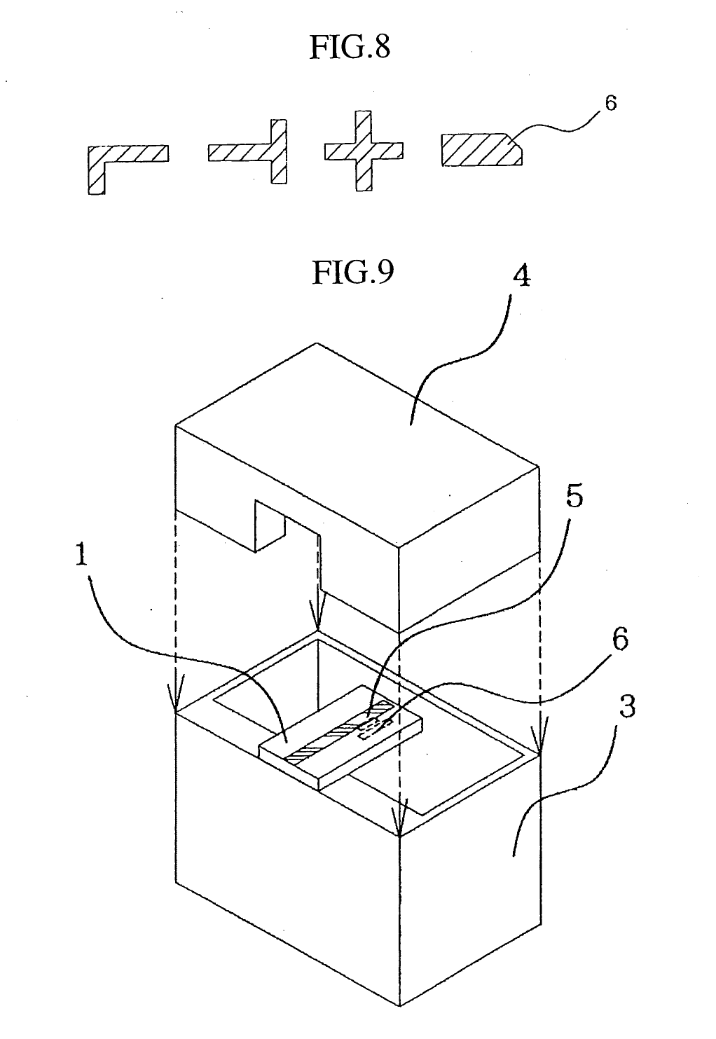

The microstripline waveguide converter according to a second embodiment 2 will be described by reference to FIG. 6 and FIG. 7. FIG. 6 is a perspective view of the configuration of a microstripline waveguide converter according to Embodiment 2 of the present invention. FIG. 7 illustrates conductor patterns disposed on the bottom surface of the dielectric substrate shown in FIG. 6.

According to the second embodiment, the shape of the strip conductor pattern 6, which is disposed on the bottom surface of the dielectric substrate 1, shown in FIG. 6 and FIG. 7, is arranged so as to be of meander-line shape, thereby enabling the band broadening of the rejection band. Moreover, according to the second embodiment, the band one-half wavelength of which is longer than the length of the strip conductor pattern 5, which projects into the waveguide 3, can be reduced.

Additionally, when the strip conductor pattern 6 has a shape of L character type, T character type, cross type, and rectangle whose corner is chamfered, shown in FIG. 8, in addition to the shape of meander line shown in FIG. 6 and FIG. 7, the similar effect can be obtained. In addition, in these conductor patterns, resonance can be caused to occur in a plurality of resonant modes at a close resonance frequency depending on the pattern shape, and the rejection band can be broadened and a plurality of rejection bands can be set by using a single strip conductor pattern 6.

As mentioned above, according to the second embodiment, similarly as in the first embodiment, the band rejection function can be provided in the inside of the converting portion of the microstripline waveguide converter. This enables the size reduction of the converter, the elimination of the working process, and the enhancement of the electric characteristics of the converter, and further enables the band broadening of the rejection band, the selection of a plurality of rejection bands, and the reduction of the band having a comparatively long wavelength.

### Third Embodiment

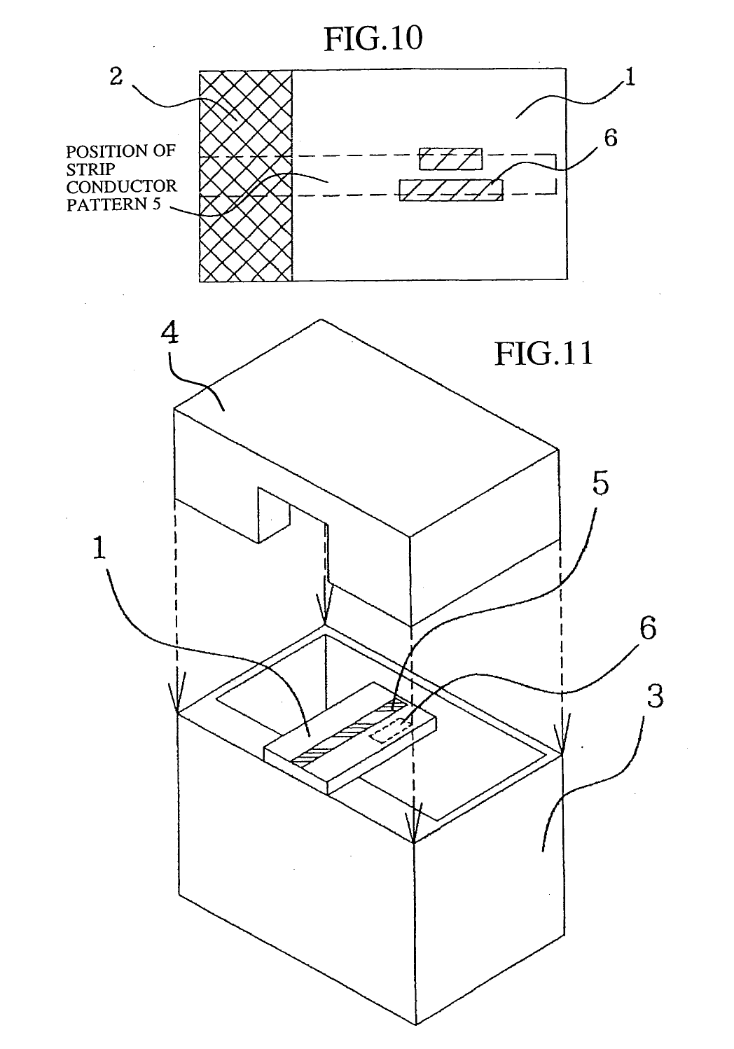

The microstripline waveguide converter according to a third embodiment of the present invention will be described by reference to FIG. 9 and FIG. 10. FIG. 9 is a perspective view of the configuration of a microstripline waveguide converter according to the third embodiment of the present invention. FIG. 10 illustrates conductor patterns disposed on the bottom surface of the dielectric substrate shown in FIG. 9.

In the third embodiment, a plurality of strip conductor patterns 6 each having a length different from each other are provided on the bottom surface of the dielectric substrate 1 shown in FIG. 9 and FIG. 10, thereby reducing a plurality of unwanted waves. Therefore, according to the third embodiment, similarly as in the first embodiment, the band rejection function can be provided in the inside of the converting portion of the microstripline waveguide converter, and additionally, a plurality of unwanted waves can be reduced.

### Fourth Embodiment

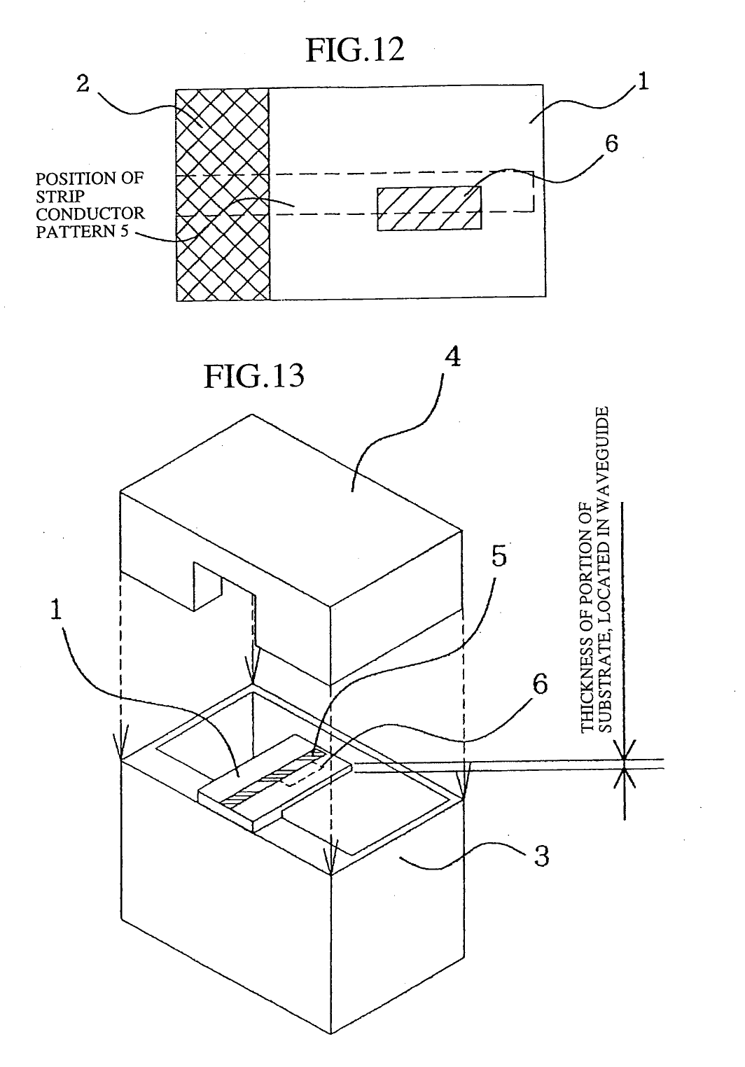

The microstripline waveguide converter according to a fourth embodiment of the present invention will be described by reference to FIG. 11 and FIG. 12. FIG. 11 is a perspective view of the configuration of a microstripline waveguide converter according to the fourth embodiment of the present invention. FIG. 12 illustrates conductor patterns disposed on the bottom surface of the dielectric substrate shown in FIG. 11.

In the fourth embodiment, the position of the strip conductor pattern 6, which is disposed on the bottom surface of the dielectric substrate 1, shown in FIG. 11 and FIG. 12, is arranged so as to be spaced from the position at which the conductor pattern overlaps with the strip conductor pattern 5 via the dielectric substrate 1, thereby carrying out the band broadening of the rejection band. The strip conductor pattern 6 resonates in the mode of the microstripline mainly with the strip conductor pattern 5 as the ground conductor. For this reason, when the overlapping portion becomes small, the Q value also becomes small at the same time, thereby enabling the band broadening of the rejection band. Therefore, according to the fourth embodiment, similarly as in the first embodiment, the band rejection function can be provided in the inside of the converting portion of the microstripline waveguide converter, and further the rejection band can be broadened.

### Fifth Embodiment

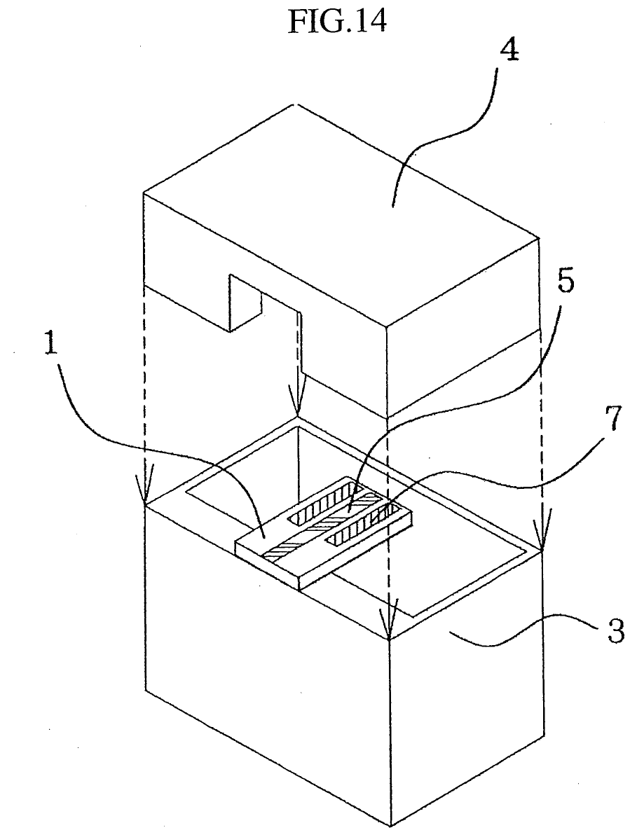

The microstripline waveguide converter according to a fifth embodiment of the present invention will be described by reference to the perspective view shown in FIG. 13. In the fifth embodiment, the thickness of the portion of the dielectric substrate 1, which projects into the waveguide 3, shown in the figure, is changed, to thereby arbitrarily adjust the width of the rejection band. The strip conductor pattern 6 resonates in the mode of the microstripline mainly with the strip conductor pattern 5 as the ground conductor. For this reason, when the thickness of the dielectric substrate 1, which separates the strip conductor pattern 6 from the pattern 5, is increased, the coupling of the transmission line with the resonance circuit becomes loose, the external Q value, which quantitatively shows the degree of this coupling, increases, and the width of the rejection band can be reduced. In contrast, when the thickness of the dielectric substrate 1 is reduced, the external Q value reduces, and thereby the width of the rejection band can be increased. Therefore, according to the fifth embodiment, similarly as in the first embodiment, the band rejection function can be provided in the inside of the converting portion of the microstripline waveguide converter, and the width of the rejection band can be arbitrarily adjusted.

### Sixth Embodiment

The microstripline waveguide converter according to a sixth embodiment of the present invention will be described by reference to the perspective view shown in FIG. 14. In the sixth embodiment, a strip conductor pattern 7 is disposed on the top surface of the dielectric substrate 1 so as to be parallel to the strip conductor pattern 5, to thereby form a resonator, and reduce the unwanted waves. Therefore, according to the sixth embodiment, similarly as in the first embodiment, the band rejection function can be provided in the inside of the converting portion of the microstripline waveguide converter, and moreover, according to this embodiment in addition to the first to fifth embodiments, a plurality of unwanted waves can be reduced.

### Seventh Embodiment

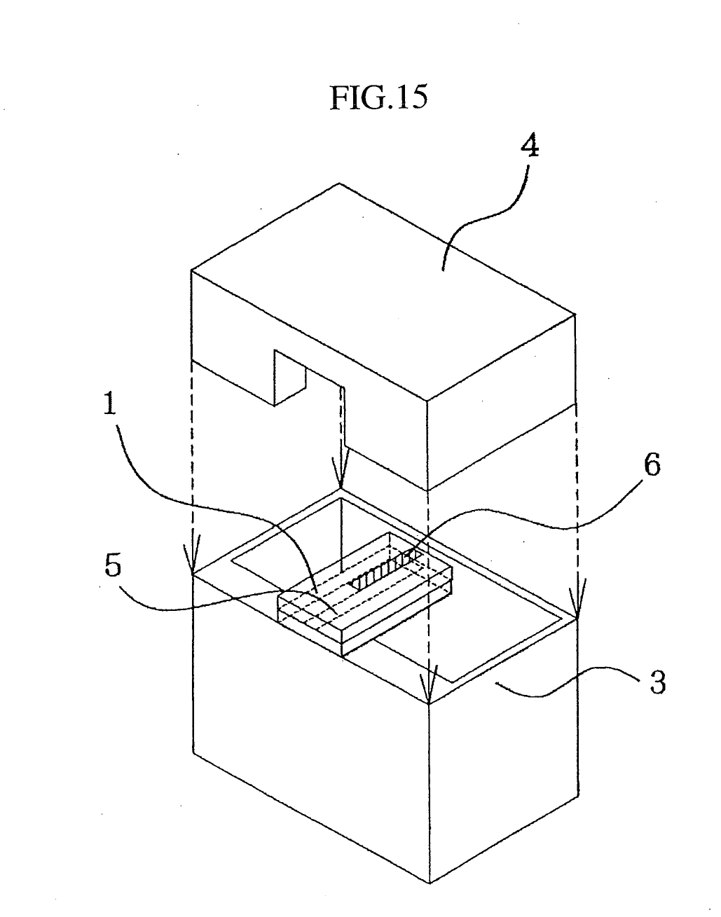

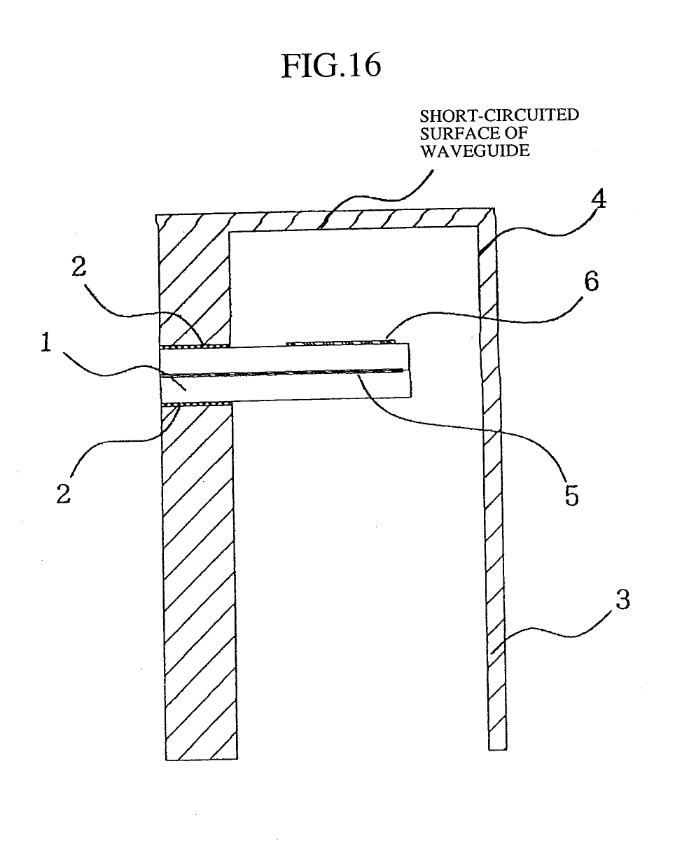

The microstripline waveguide converter according to a seventh embodiment of the present invention will be described by reference to the perspective view shown in FIG. 15 and the sectional view shown in FIG. 16. In FIG. 15 and FIG. 16, the reference numeral 1 represents a dielectric substrate consisting of multilayered boards, and the numeral 5 represents a strip conductor pattern formed on the inner layer of the dielectric substrate 1. In these figures, the dielectric substrate 1, the ground conductor pattern 2, and the strip conductor pattern 5 constitute a “microstripline.” On the layer of the dielectric substrate 1, which is different from the layer on which the strip conductor pattern 5 is disposed, the strip conductor pattern 6 is disposed at the position where the pattern 6 overlaps with the pattern 5, to thereby form a resonator, and reduce the unwanted waves. Therefore, according to the seventh embodiment, similarly as in the first embodiment, the band rejection function can be provided in the inside of the converting portion of the stripline/waveguide converter. Moreover, according to this embodiment in addition to the first to sixth embodiments, at the same time, a plurality of unwanted waves can be reduced, the bandwidth of the rejection band can be increased, and the band having a comparatively long wavelength can be reduced.

### Eighth Embodiment

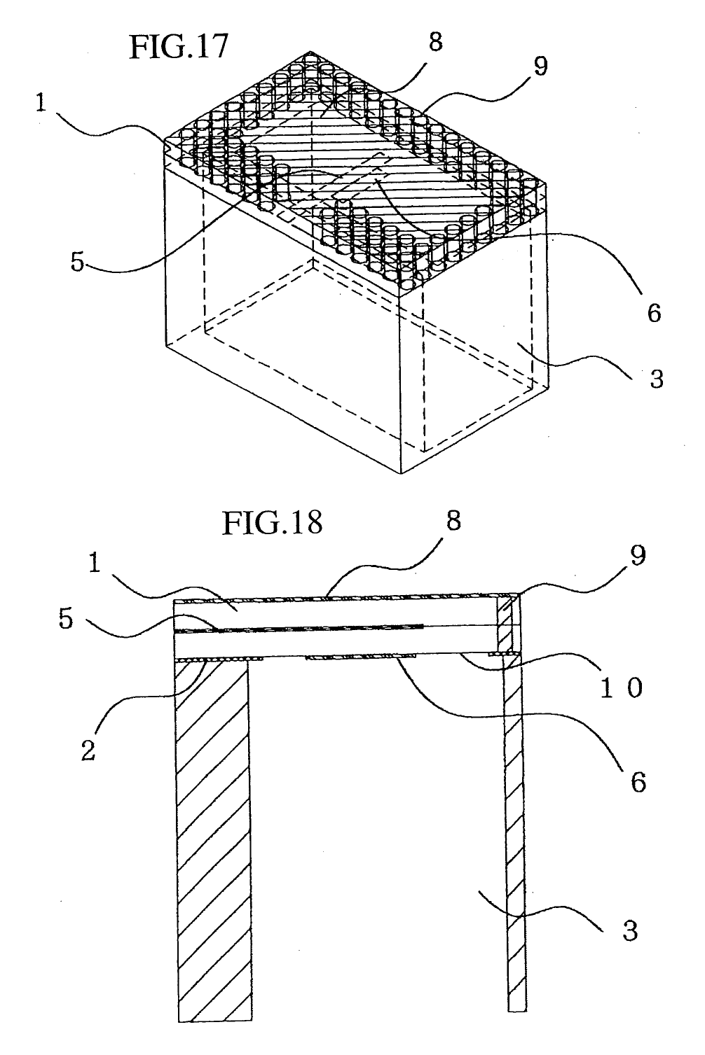

The microstripline waveguide converter according to an eighth embodiment of the present invention will be described by reference to the perspective view shown in FIG. 17 and the sectional view shown in FIG. 18. In the figures, the reference numeral 1 represents a dielectric substrate consisting of multilayered boards, the numeral 2 represents a ground conductor pattern, the numeral 3 represents a waveguide, the numeral 5 represents a strip conductor pattern formed on the dielectric substrate 1, the numeral 6 represents a strip conductor pattern formed on the bottom surface of the dielectric substrate, the numeral 8 represents a “conductor pattern for short-circuiting the waveguide,” the numeral 9 represents a “via (conductor for connection) for the wall of the waveguide,” and the numeral 10 represents a “portion having no ground conductor pattern,” respectively. The term “via” is used as a term denoting a columnar conductor in this specification.

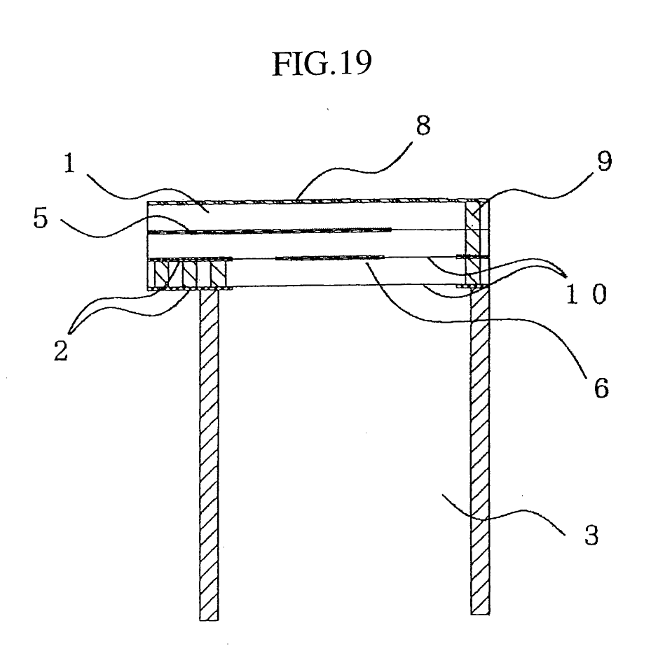

In these figures, the “via for the wall of the waveguide” 9 is provided in the vicinity of the “portion having no ground conductor pattern” 10, and connects the ground conductor pattern 2 and the “conductor pattern for short-circuiting the waveguide” 8. Further, the ground conductor pattern 2, the “conductor pattern for short-circuiting the waveguide” 8, and the “via for the wall of the waveguide” 9 constitute a “Dielectric-waveguide-short-circuiting portion.” The waveguide 3 is connected to the place where the “portion having no ground conductor pattern” 10 is positioned on the bottom surface of the dielectric substrate 1. Moreover, as shown in the sectional view of FIG. 19, the waveguide can be also connected to the “Dielectric-waveguide” consisting of the dielectric substrate and the “via for the wall of the waveguide.”

Similarly as in the first embodiment, the strip conductor pattern 6 is disposed at the position where the pattern overlaps with the strip conductor pattern 5 via the dielectric substrate 1, to thereby form a resonator, and reduce the unwanted waves. Therefore, according to the eighth embodiment, similarly as in the first embodiment, the band rejection function can be provided in the inside of the converting portion of the stripline/waveguide converter, thereby enabling the size reduction of the converter, the elimination of the working process, and the enhancement of the electric characteristics of the converter. In addition, according to this embodiment in addition to the second to seventh embodiments, a plurality of unwanted waves can be reduced, the rejection band can be broadened, and the band having a comparatively long wavelength can be reduced, at the same time.

### Ninth Embodiment

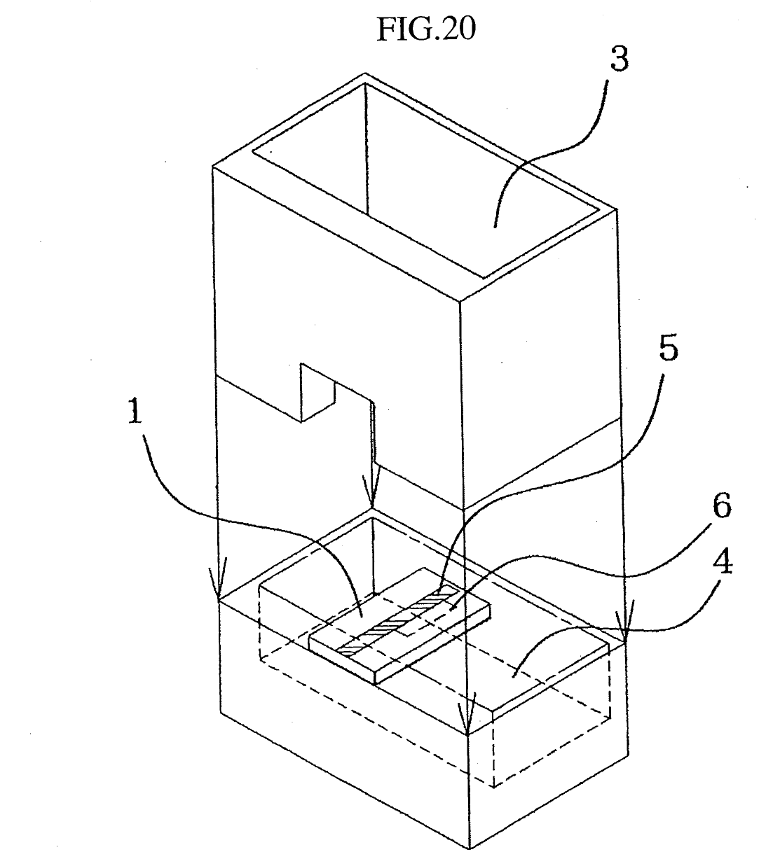

The microstripline waveguide converter according to a ninth embodiment of the present invention will be described by reference to the perspective view shown in FIG. 20.

In the ninth embodiment, the-short-circuited waveguide 4 is disposed below the dielectric substrate 1, and the waveguide 3 is disposed thereabove. Similarly as in the first embodiment, the strip conductor pattern 6 is disposed at the position where the pattern overlaps with the strip conductor pattern 5 via the dielectric substrate 1, to thereby form a resonator, and reduce the unwanted waves. Therefore, according to the ninth embodiment, similarly as in the first embodiment, the size of the microstripline waveguide converter having the band rejection function can be reduced, the working process can be eliminated, and the electric characteristics of the converter can be enhanced. Moreover, also in the second to eighth embodiments, the short-circuited surface of the waveguide can be disposed below the dielectric substrate 1, and the waveguide can be disposed above the dielectric substrate 1.

### Tenth Embodiment

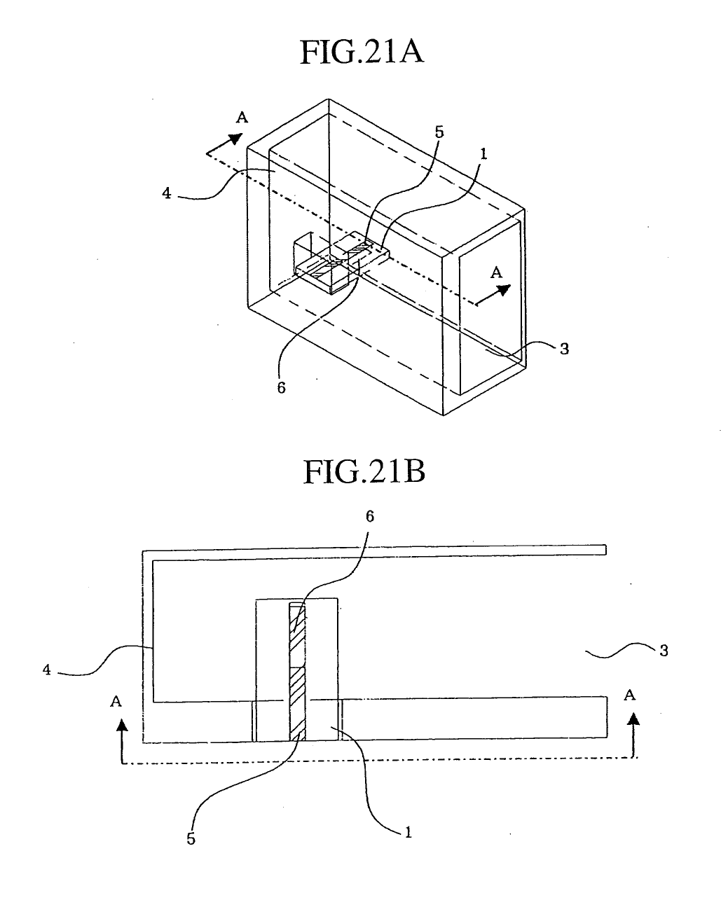

The microstripline waveguide converter according to a tenth embodiment of the present invention will be described by reference to the perspective view shown in FIG. 21A and the sectional view shown in FIG. 21B (sectional view taken on the line A-A).

In the tenth embodiment, the short-circuited waveguide 4 is disposed on a lateral side of the dielectric substrate 1, and the waveguide 3 is disposed on the opposite side from the short-circuited waveguide 4 via the dielectric substrate 1. Similarly as in the first embodiment, the strip conductor pattern 6 is disposed at the position where the pattern overlaps with the strip conductor pattern 5 via the dielectric substrate 1, to thereby form a resonator, and reduce the unwanted waves. Therefore, according to the tenth embodiment, similarly as in the first embodiment, the size of the microstripline waveguide converter having the band rejection function can be reduced, the working process can be eliminated, and the electric characteristics of the converter can be enhanced. Moreover, also in the second to eighth embodiments, the short-circuited surface of the waveguide can be disposed on the right or left side of the dielectric substrate 1, and the waveguide can be disposed on the left or right side of the dielectric substrate 1.

As mentioned above, the microstripline waveguide converter according to the present invention includes the band rejection function, and thereby the converter is suitably used for a power converting circuit mainly in the microwave band and the millimeter wave band.

1. A microstripline waveguide converter comprising:
a waveguide having an opening hole in the sidewall thereof, and having a short-circuited surface on one of the ends thereof;
a dielectric substrate extending through this opening hole of the waveguide toward the inside of the waveguide;
a ground conductor pattern formed on one surface of this dielectric substrate, and mounted in the opening hole of the waveguide;
a strip conductor pattern for transmitting a signal, formed on the other surface of the dielectric substrate and extending to the inside of the waveguide; and
a strip conductor pattern for resonance, which is adjacent to this strip conductor pattern, is electrically insulated from the waveguide, is formed on the portion of the dielectric substrate, which is located within the waveguide, and has a finite length.

2. A microstripline waveguide converter comprising:
a waveguide having an opening hole in the sidewall thereof, and having a short-circuited surface on one of the ends thereof;
a multilayered dielectric substrate extending through this opening hole of the waveguide toward the inside of the waveguide;
a ground conductor pattern formed on both the outer layer surfaces of this dielectric substrate, and mounted in the opening hole of the waveguide;
a strip conductor pattern for transmitting a signal, formed on the inner layer surface of the dielectric substrate, and extending to the inside of the waveguide; and
a strip conductor pattern for resonance, which is adjacent to this strip conductor pattern, is electrically insulated from the waveguide, is formed on the portion of the dielectric substrate, which is located within the waveguide, and has a finite length.

3. A microstripline waveguide converter comprising:
a waveguide one end of which is opened;
a multilayered dielectric substrate that is mounted so as to close the opened portion of this waveguide;
a ground conductor pattern that is formed on one outer layer surface of the dielectric substrate, corresponding to the wall of the section of the waveguide in the opened portion;
a short-circuit conductor pattern that is formed on the other outer layer surface of the dielectric substrate;
a strip conductor pattern for transmitting a signal, formed on one inner layer surface of the dielectric substrate, and extending to the inside of the waveguide;
a strip conductor pattern for resonance, which is adjacent to this strip conductor pattern, is electrically insulated from the waveguide, is formed on the portion of the dielectric substrate, which is located within the waveguide, and has a finite length; and
a conductor for connection, which is formed through the dielectric substrate, and electrically short-circuits the ground conductor pattern and the short-circuit conductor pattern.

4. A microstripline waveguide converter according to claim 1, wherein a rejection band is formed at the position of a predetermined frequency by changing the length of the strip conductor pattern for resonance.

5. A microstripline waveguide converter according to claim 2, wherein a rejection band is formed at the position of a predetermined frequency by changing the length of the strip conductor pattern for resonance.

6. A microstripline waveguide converter according to claim 3, wherein a rejection band is formed at the position of a predetermined frequency by changing the length of the strip conductor pattern for resonance.
